(19) United States
(12) Patent Application Publication
(10) Pub. No.: US 2015/0205686 A1
(43) Pub. Date: Jul. 23, 2015

(54) DATA PROCESSING DEVICE AND METHOD

(71) Applicant: FUJITSU LIMITED, Kawasaki-shi (JP)

(72) Inventor: Yasushi Ishibashi, Sagamihara (JP)

(73) Assignee: FUJITSU LIMITED, Kawasaki-shi (JP)

(21) Appl. No.: 14/674,686

(22) Filed: Mar. 31, 2015

Related U.S. Application Data
(63) Continuation of application No. PCT/JP2012/076526, filed on Oct. 12, 2012.

(51) Int. Cl. G06F 11/20; G06F 11/14; G06F 3/06; G06F 11/30

(52) U.S. Cl. CPC G06F 11/2033; G06F 11/2069; G06F 11/3034; G06F 11/1456; G06F 11/1435; G06F 3/0619; G06F 3/0659; G06F 3/0653; G06F 3/0689

(57) ABSTRACT

A data processing device includes a processor configured to execute a process. The process includes: outputting, toward a specific storage device among plural storage devices including switchable storage devices that are subjected to redundancy by a redundancy section so as to store the same data as another storage device, request information that requests data input/output processing, and instructing input/output of the data; performing input/output of data for each of the plural storage devices, and giving a response after the request information has been received; and pre-storing redundancy information related to the redundant switchable storage devices, and based on the redundancy information, monitoring responses to the request information aimed at the redundant switchable recording devices.

### CROSS-REFERENCE TO RELATED APPLICATION

This application is a continuation application of International Application No. PCT/JP2012/076526, filed Oct. 12, 2012, the disclosure of which is incorporated herein by reference in its entirety.

### FIELD

The embodiments discussed herein are related to a data processing device, a data processing method, and a recording medium storing a data processing program.

### BACKGROUND

Data processing systems that perform business processing using computers are known. Data used when performing business processing using computers is generally stored on a storage device, such as a hard disk drive (HDD), for use. To suppress the impact of storage device failure on business processing, redundancy of storage devices is effected using redundancy technologies known, for example, as redundant arrays of inexpensive disks (RAID) or mirroring.

For example, in the redundancy technology known as a RAID, plural disk drives operate as a virtual single disk. In the technology known as disk mirroring, the same content is stored on plural local disk drives. In redundancy technology, data is written to plural disks or to plural storage devices simultaneously, and data is read from a predetermined master disk or master storage device.

In redundancy technology, when the master disk or master storage device fails, a recovery process is swiftly performed, such as a switch that designates another disk or another storage device as the master. Occurrence of disk or storage device failure, and the time then required for processing in order to recover from the failure by, for example, switching to another disk or another storage device, are impediments to the continuation of business processing when business processing is being performed using computers. Redundancy technology is, therefore, desired in which business processing continues smoothly.

For example, a technology is known in which data is kept synchronized between an operating-type server and a standby-type server, and specific memory regions are utilized when recovery is made from the standby-type server, which has been switched to during an abnormality. Duplication of all data from the standby-type server to the operating-type server is necessitated when switching from the standby-type server to the recovered operating-type server. Difference information for the standby-type server since the timing of the switch during the abnormality is determined, and recovery from the standby-type server to the operating-type server utilizes specific memory regions indicated by the difference information.

Technology is also known that improves throughput when switching between servers, and ensures input/output performance and reliability for large capacity storage devices. In this technology, input/output paths are replicated, and the input/output performance and reliability for the server is ensured by switching between servers if failures occurring in a specific number of the input/output paths are detected.

When an abnormality occurs in a disk or storage device subject to redundancy using redundancy technology, responses from the disk drive or storage device are delayed, and this is sometimes an impediment to business processing continuity. In data systems that use redundancy technology, response delays of disk drives can be suppressed using timeout technology.

For example, technology in which I/O requests are repeated continuously when responses to input/output (I/O) requests are abnormal, is known as technology related to response delays from a disk or the like in a disk drive that controls an HDD or the like. In this technology, when abnormal information is first received from a disk drive at the host side of the disk drive, I/O requests are repeated at the host side of the disk drive only, and an abnormality is detected. A known example of a detected abnormality is a timeout in which a response to an I/O request takes more than a specific time. In the technology in which I/O requests are repeated at the host side of a disk drive, when abnormal information such as a timeout is received at the host side of the disk drive, retry processing is executed that promptly repeats I/O requests. In the technology that executes retry processing that promptly repeats I/O requests, abnormalities can be detected within a short time compared to technology that repeats I/O requests to a disk drive each time there is a timeout of a response to an I/O request.

### Related Patent Documents

Japanese Laid-Open Patent Publication No. 2008-140086
Japanese Laid-Open Patent Publication No. 2005-149281
Japanese Laid-Open Patent Publication No. 2006-31335

### SUMMARY

According to an aspect of the embodiments, a data processing device includes a processor configured to execute a process. The process includes: outputting, toward a specific storage device among plural storage devices including switchable storage devices that are subjected to redundancy by a redundancy section so as to store the same data as another storage device, request information that requests data input/output processing, and instructing input/output of the data; performing input/output of data for each of the plural storage devices, and performing a response after the request information has been received; and pre-storing redundancy information related to the redundant switchable storage devices, and based on the redundancy information, monitoring responses to the request information aimed at the redundant switchable recording devices.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating a data processing device according to a first exemplary embodiment;

FIG. 2 is a block diagram illustrating an example of a computer system;

FIG. 3 is an illustrative diagram illustrating an example of a disk table;

FIG. 4 is an illustrative diagram illustrating an example of a management table;

FIG. 5 is a functional block diagram illustrating an example of a function related to operation of a computer;

FIG. 6 is an illustrative diagram illustrating an example of a layer structure related to operation in a computer;

FIG. 7 is a flowchart illustrating an example of a flow of I/O monitoring driver processing;

FIG. 8 is a flowchart illustrating an example of a flow of timeout determination processing;

FIG. 9 is a flowchart illustrating an example of a flow of management daemon process processing;

FIG. 10 is a flowchart illustrating an example of a flow of a registration process for a disk table;

FIG. 11 is a flowchart illustrating an example of a flow of registration process for a management table;

FIG. 12 is a functional block diagram illustrating an example of functionality relating to operation of a computer according to a second exemplary embodiment;

FIG. 13 is an illustrative image illustrating an example of a disk table according to the second exemplary embodiment;

FIG. 14 is an illustrative diagram illustrating an example of a management table according to the second exemplary embodiment; and

FIG. 15 is a flowchart illustrating an example of a flow of management daemon process processing according to the second exemplary embodiment.

### DESCRIPTION OF EMBODIMENTS

In data processing systems that use redundancy technology, response delays in disk drives are suppressed using timeout technology. In timeout technology, a timeout time is predetermined for I/O requests, and response times to disk drive I/O requests are monitored. When there is an abnormality on an HDD, or when there is an abnormality in a communications path, disk drives repeatedly execute I/O requests because the response times of the I/O requests are abnormal. In timeout technology, an I/O request issued to the disk drive is cancelled when the response time being monitored exceeds the predetermined timeout time. If the I/O request is cancelled, business processing is continued using another disk or storage device subjected to redundancy by redundancy technology.

For example, when disks are subjected to redundancy using processing of disk mirroring software or the like, if a response delay arises in one of the disks, I/O requests to the one disk are cancelled by timeout technology. The I/O requests are then issued to another disk, and business processing continues using the other disk. When servers are subjected to redundancy using processing of clustering software or the like, if a response delay arises at one server that is operating, I/O requests to the one server are cancelled by timeout technology. Operation is then switched to another server by processing such as clustering software, and business processing is continued on the switch-destination server.

However, in order to use suppress suspension of business processing by timeout technology in data processing systems, it is a prerequisite that disks or storage devices subjected to redundancy by redundancy technology are already known. Namely, in order to use timeout technology, information is acquired in advance to indicate the configurations and operation states of disks or storage devices subjected to redundancy using redundancy technology. The acquired information is then used to switch operation from disks or storage devices in which response delays arise, to redundant disks or storage devices.

However, acquiring information indicating the configurations and operation states of disks or storage devices that have been subjected to redundancy using redundancy technology is sometimes problematic when timeout technology is employed in the data processing system. For example, the use of timeout technology is sometimes not considered when software that subjects disk or storage devices to redundancy using redundancy technology is independently introduced by a user. It is accordingly sometimes not possible to employ timeout technology with redundancy technology operating in a data processing system, even though the data processing system has a configuration or state enabling business continuation using timeout technology. When it is not possible to use timeout technology with redundancy technology operating in a data processing system, system outages and business suspension sometimes occur as a result.

An object of one aspect of technology disclosed herein is, in accordance with redundancy technology in operation, to enable business processing to be continued without delays, and to increase availability for business processing.

Detailed explanation follows regarding examples of exemplary embodiments of technology disclosed herein with reference to the drawings.

### First Exemplary Embodiment

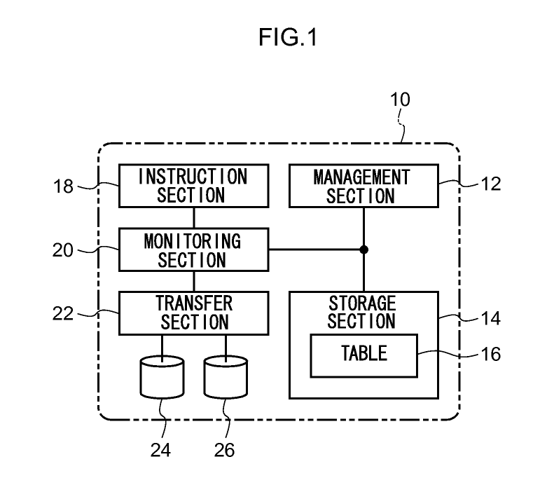

FIG. 1 illustrates a configuration of a data processing device 10 according to a first exemplary embodiment. The data processing device 10 includes an instruction section 18, a monitoring section 20, a transfer section 22, a management section 12, and a storage section 14 that includes a table 16. The monitoring section 20, the management section 12, and the storage section 14 are each connected together. The transfer section 22 is connected to plural storage devices. FIG. 1 illustrates an example in which two storage devices 24, 26 are connected to the transfer section 22. Note that the plural storage devices are not limited to two, and three or more thereof may be employed.

In the first exemplary embodiment, explanation is given of a case in which timeout technology is applied when plural storage devices are subjected to redundancy in the data processing device 10. The storage device 24 is designated as the master storage device of the plural storage devices in the following explanation.

The data processing device 10 is an example of a data processing device of technology disclosed herein. The instruction section 18 is an example of an instruction section of technology disclosed herein. The monitoring section 20 is an example of a monitoring section of technology disclosed herein. The table 16 included in the storage section 14 is an example of a table of technology disclosed herein.

In the data processing device 10, to suppress time response delays for a redundant storage device, the table 16 registered with redundancy information of the storage devices 24, 26 that are subject to redundancy in the data processing device 10 is included in the storage section 14. Examples of redundancy information include a title (disk name) of a disk that identifies a redundant disk, and a title of a command for checking the redundancy state for redundancy software that subjects a storage device to redundancy.

In the data processing device 10, the instruction section 18 instructs input/output of data by outputting request data that requests input/output of data to/from the storage devices 24, 26 that have been subjected to redundancy using redundancy software. The monitoring section 20 monitors the input/output (I/O) to/from the storage devices 24, 26. When either of the storage devices 24, 26, which are being I/O monitored and from which input/output was requested, does not respond within a predetermined response time, the monitoring section 20 executes processing to suppress the response delay of the storage device. For simplicity of explanation, a case is explained in which the storage devices 24, 26 are subjected to redundancy, and requests for data input/output are made to the storage device 24.

When an I/O request is issued, the monitoring section 20 calls on the management section 12 to perform processing to check the redundancy state of the target storage device 24. When a call is received from the monitoring section 20, the management section 12 references the table 16 stored in the storage section 14, acquires the redundancy state based on the redundancy information of the call-target storage device 24, and returns the redundancy state to the monitoring section 20. Since the storage device 24 is subject to redundancy together with the storage device 26, business processing can continue even if a response to an I/O request made to the storage device 24 times out, since the storage device to be employed switches from the storage device 24 to the storage device 26.

The management section 12 returns a redundancy state, including information indicating the possibility of a timeout, to the monitoring section 20. The monitoring section 20 outputs information indicating that no response came from the storage device 24 to the instruction section 18, based on the redundancy state returned by the management section 12. The instruction section 18 switches the storage device to be used, from being the storage device 24 to the storage device 26, using information output from the monitoring section 20. Occurrence of response delays can accordingly be suppressed for I/O requests to storage devices subjected to redundancy using redundancy software. Thereby, the response time can be shortened and the availability of the device can be increased, even when response delays occur for I/O.

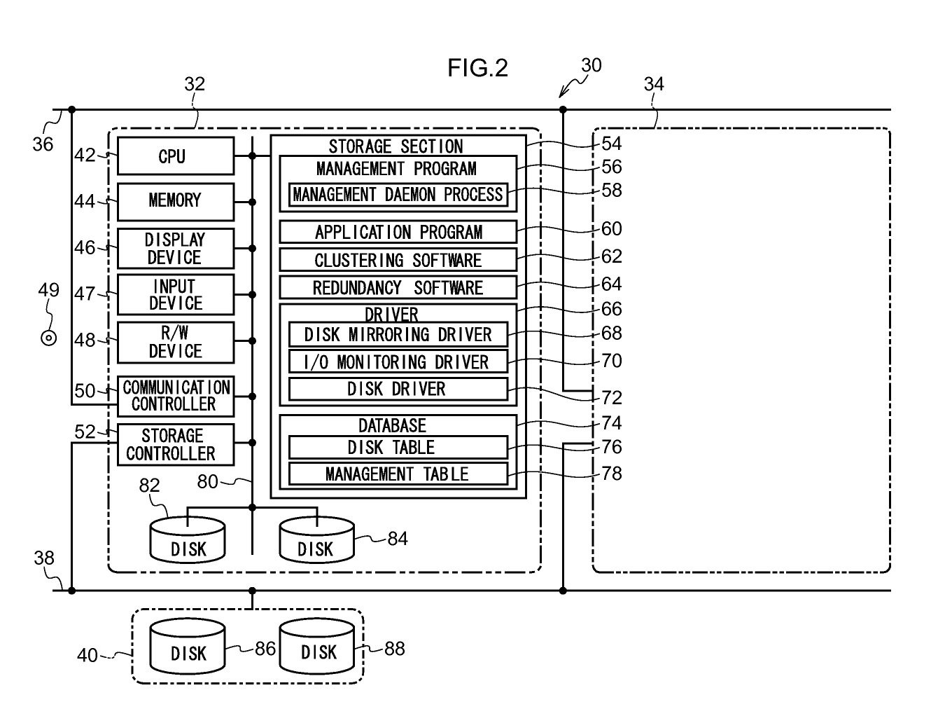

FIG. 2 illustrates an example in which the data processing device 10 is implemented by a computer included in a computer system 30. The computer system 30 includes two similarly configured computers 32, 34. The computers 32, 34 are connected to each other through a communications network 36. The computer system 30 includes storage 40 for storing data that is being used commonly between the computers 32, 34. The computers 32, 34, and the storage 40 are connected to one another through a storage network 38. The storage 40 includes disks 86, 88, and the disks 86, 88 are subjected to redundancy.

The computer 32 includes a CPU 42, memory 44, and a non-volatile storage section 54. The CPU 42, the memory 44, and the storage section 54 are connected to one another through a bus 80. The storage section 54 may be implemented using a HDD, flash memory, or the like. The computer 32 includes a communication controller 50 for connecting to the network 36, and the communication controller 50 is connected to the bus 80. The computer 32 includes a display device 46 serving as an example of an output device, and an input device 47 serving as an example of an input device, such as a keyboard or mouse. The display device 46 and the input device 47 are connected to the bus 80. The computer 32 is provided with a device (an R/W device) 48 for reading/writing a recording medium 49 such as an optical disc when the recording medium 49 is inserted into the computer 32, and the R/W device 48 is connected to the bus 80. Note that the display device 46, the input device 47, and the R/W device 48 may be omitted, or may be connected to the bus 80 when necessary.

The computer 32 includes a storage controller 52 for connecting to the storage network 38, and the storage controller 52 is connected to the bus 80. The computer 32 is provided with discs 82, 84 for storing data, and the discs 82, 84 are connected to the bus 80. The discs 82, 84 are configured redundantly (detailed explanation follows).

A management program 56, application programs 60, clustering software 62, and redundancy software 64 are stored in the storage section 54. The management program 56, the application programs 60, the clustering software 62, and the redundancy software 64 are classified as software executed at a user layer above the operating system (OS). A driver 66 is stored in the storage section 54 and is classified as software that executes on the kernel layer of the OS. A database 74 that includes a disk table 76 and a management table 78 is stored in the storage section 54.

The application programs 60 are various programs that execute on the computer 32. The clustering software 62 is software that executes redundancy processing on computers, such as servers. The CPU 42 subjects the computers 32, 34 to redundancy by reading the clustering software 62 from the storage section 54, expanding the clustering software 62 into the memory 44, and executing the clustering software 62. The redundancy software 64 is software that executes redundancy processing of the storage device. The CPU 42 subjects the discs 82, 84 to redundancy by reading the redundancy software 64 from the storage section 54, expanding the redundancy software 64 into the memory 44, and executing the redundancy software 64.

In the first exemplary embodiment, the management program 56 and the driver 66 are executed to suppress response delays of redundant storage devices. The CPU 42 reads the management program 56 from the storage section 54, expands the management program 56 into the memory 44, and executes processes of the management program 56. The CPU 42 reads the driver 66 from the storage section 54, expands the driver 66 into the memory 44, and executes the driver 66. Namely, the data processing device 10 is implemented by the computer 32, and the computer 32 operates as the data processing device 10 due to the CPU 42 executing the management program 56 and the driver 66.

Note that portions of the management program 56 and the driver 66 are examples of a data processing program of technology disclosed herein. The management program 56 and the driver 66 are also programs that cause the computer 32 to function as a data processing device. The recording medium 49, such as an optical disc on which a program that causes the computer 32 to execute processing is recorded, is an example of a recording medium of technology disclosed herein. The storage section 54, implemented by, for example, a hard disk drive (HDD), is an example of a recording medium of technology disclosed herein. The redundancy software 64 is an example of a redundancy section of technology disclosed herein.

The driver 66 includes a disk mirroring driver 68, an I/O monitoring driver 70, and a disk driver 72. The disk mirroring driver 68 accepts input/output data for the disks from the application program 60. The disk mirroring driver 68 then instructs input/output of data by outputting to the discs 82, 84, which are subjected to redundancy by executing the redundancy software 64, request information requesting input/output processing of data. The CPU 42 operates as the instruction section 18 in the data processing device 10 illustrated in FIG. 1 by executing the disk mirroring driver 68. Namely, the data processing device 10 is implemented by the computer 32, and the computer 32 operates as the instruction section 18 of the data processing device 10 by executing the disk mirroring driver 68.

The disk driver 72 executes input/output of data to/from the discs 82, 84. Namely, processing for input/output of data to/from the discs 82, 84 is processed when the disk driver 72 requests data input/output to/from the discs 82, 84. The CPU 42 operates as the transfer section 22 in the data processing device 10 illustrated in FIG. 1 by executing the disk driver 72. Namely, the data processing device 10 is implemented by the computer 32, and the computer 32 operates as the transfer section 22 of the data processing device 10 by executing the disk driver 72.

The I/O monitoring driver 70 executes processing to monitor response times of input/output (I/O) between the disk mirroring driver 68 and the disk driver 72. As explained in more detail below, the I/O monitoring driver 70 determines an I/O response delay to have occurred when there is no response from the disk driver 72 within the I/O timeout time, and a management daemon process 58 then enquires whether or not timeout functionality is implementable. The I/O monitoring driver 70 implements the I/O timeout functionality if the I/O timeout functionality is implementable according to the enquiry result. The CPU 42 operates as the monitoring section 20 in the data processing device 10 illustrated in FIG. 1 by executing the I/O monitoring driver 70. Namely, the data processing device 10 is implemented by the computer 32, and the computer 32 operates as the monitoring section 20 of the data processing device 10 by executing the I/O monitoring driver 70.

The management program 56 includes the management daemon process 58. The management daemon process 58 is a user layer program that handles processing that is difficult to implement in the I/O monitoring driver 70, which is classified as being a kernel layer. When the management daemon process 58 receives an enquiry from the I/O monitoring driver 70, the management daemon process 58 checks the management table 78 of the redundancy software, and issues a command that checks the redundancy state for the operating redundancy software. Based on the reply to the command from the redundancy software, the management daemon process 58 determines whether or not I/O timeout functionality is implementable, and responds to the I/O monitoring driver 70 with the determination result. The CPU 42 operates as the management section 12 in the data processing device 10 illustrated in FIG. 1 by executing the management daemon process 58. Namely, the data processing device 10 is implemented by the computer 32, and the computer 32 operates as the management section 12 of the data processing device 10 by executing the management daemon process 58.

The command that checks the redundancy state issued for the redundancy software, makes an enquiry to the redundancy software 64 as to the redundancy state of the target disk, and instructs the redundancy software 64 to provide notification as to whether I/O timeout functionality is executable. For example, when disks are subjected to redundancy by processing of disk mirroring software or the like, information indicating that the disk mirroring processing operating state of the disk mirroring processing for the target disk is normal, and whether or not the other disk is degenerated, or operating normally, is given in reply to the command. For example, in cases in which a server is subjected to redundancy by clustering software or the like, information indicating whether or not a switch destination computer is able to operate normally for the clustering software that is using the target disk is given in reply to the command.

The database 74 stored in the storage section 54 of the computer 32 includes the disk table 76, and the management table 78. The database 74 corresponds to the storage section 14 of the data processing device 10 illustrated in FIG. 1. Namely, when the data processing device 10 is implemented by the computer 32 in the computer system 30, the database 74 that includes the disk table 76 and the management table 78 corresponds to the storage section 14.

The disk table 76 is used to discriminate between redundant disks in the I/O monitoring driver 70, and information for managing the redundant disks is stored in the database 74 as a table. Examples of information for managing redundant disks include the title (disk name) of the disk that identifies the redundant disk.

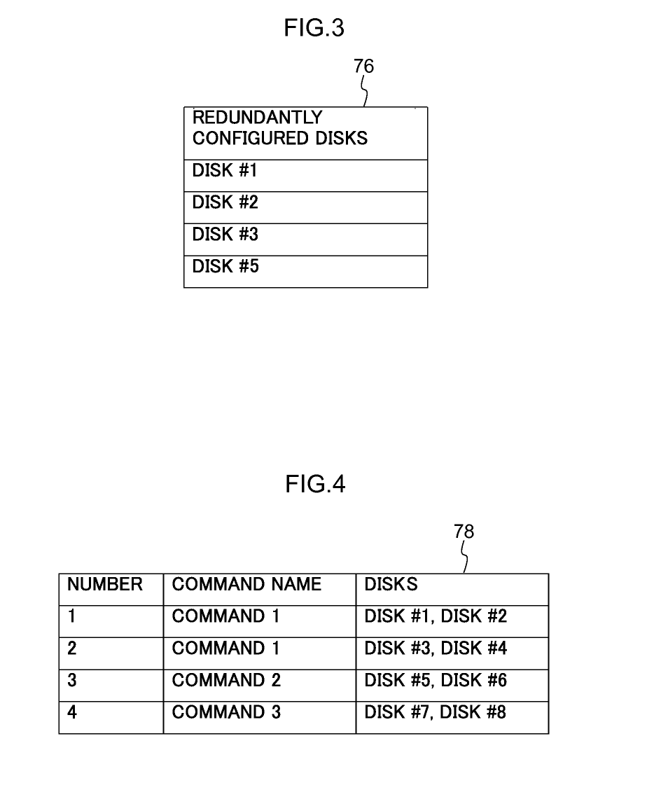

FIG. 3 illustrates an example of the disk table 76. The disk table 76 is registered with disk names that identify redundant disks, as REDUNDANTLY CONFIGURED DISK items. FIG. 3 illustrates an example in which titles of redundant disks are stored in REDUNDANTLY CONFIGURED DISK items as DISK #1, DISK #2, DISK #3, and DISK #5.

The disk table 76 is preregistered by the user. For example, when registration, modification, or removal of a disk subjected to redundancy by the redundancy software 64 occurs, the user starts up a registration process of a disk table included in the management program 56, and instructs the registration, modification, or removal of the disk in the disk table 76.

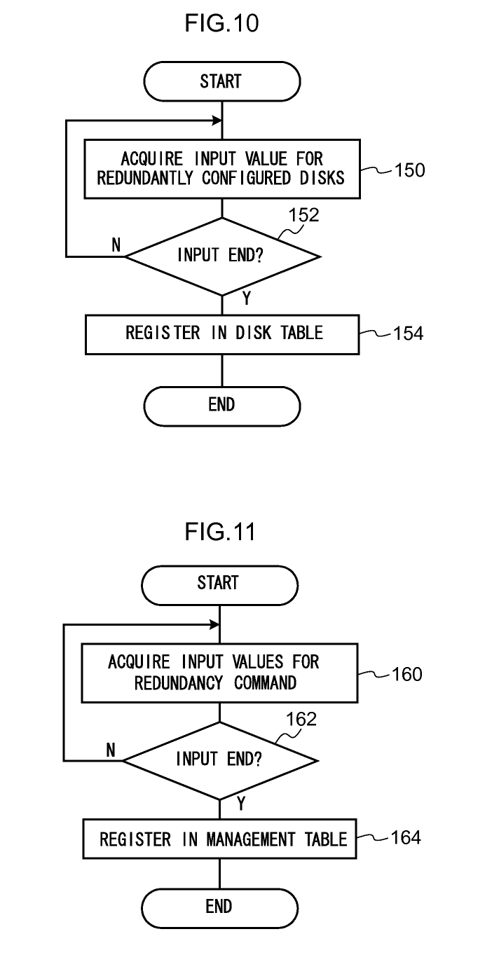

FIG. 10 illustrates an example of flow of a registration process for registration in the disk table 76. The processing routine illustrated in FIG. 10 is started during operation of the computer 32 by the user operating the input device 47 and, for example, instructing execution of the registration process. First, the user inputs information indicating redundantly configured disks, namely, the titles of the redundant disks, by operating the input device 47. At step 150, the CPU 42 of the computer 32 acquires an information input value input by the user as an information input value relating to redundantly configured disks. Next, when, for example, there has been no key-press instruction via a predetermined END key during the operation of the input device 47 by the user (when negative determination is made at step 152), the CPU 42 repeats acquisition of information input values related to the redundantly configured disks until there is a key-press instruction. When affirmative determination is made at step 152, at step 154, the CPU 42 registers the input values acquired at step 150 in the disk table 76, and ends the present processing routine.

The management table 78 is used as an argument when the management daemon process 58 makes an enquiry to the redundancy software 64. The information related to the enquiry made to the redundancy software 64 is stored in the database 74 as a table. Examples of information related to the enquiry made to the redundancy software 64 include a check command name for the redundancy state corresponding to the redundancy software 64, and a registered disk name.

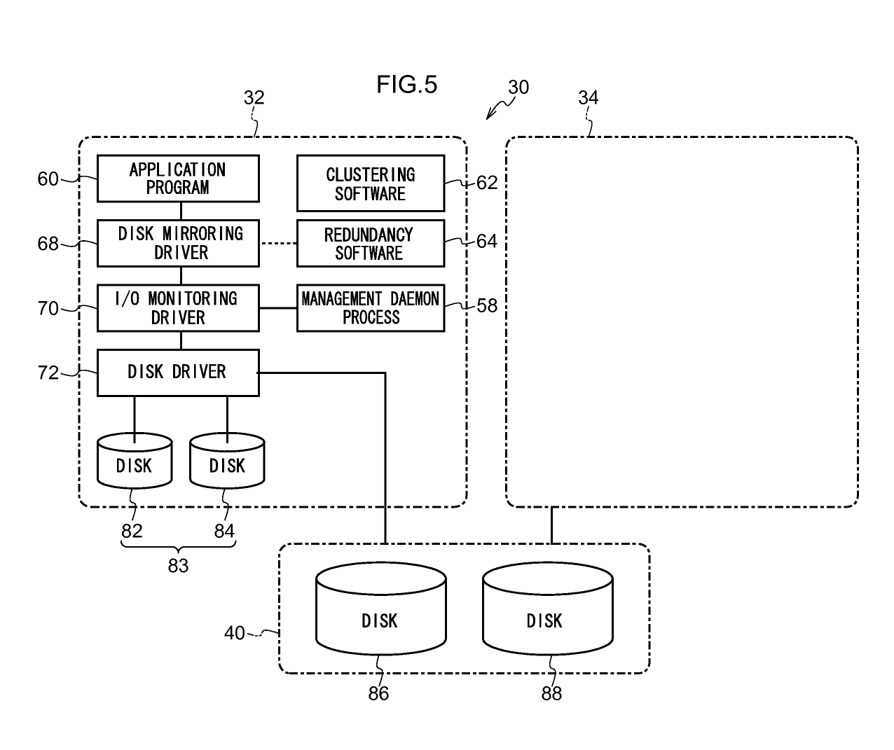

FIG. 4 illustrates an example of a management table 78. Information representing a NUMBER, a COMMAND NAME, and DISKS are each stored associated with one another in the management table 78.

The information representing the NUMBER item is information indicating a registration sequence. The information representing the COMMAND item is a command name of an order representing an enquiry to the target redundancy software. The information representing the DISKS item is information indicating combinations of disks made redundant with one another by the target redundancy software. The example number 1 illustrated in FIG. 4 has “1” as the NUMBER item, COMMAND 1 as the COMMAND NAME item, and DISK #1, DISK #2 as the DISKS item, and these are registered in association with one another.

The management table 78 is preregistered by the user. For example, when registration, modification, or removal has appeared in the information related to the enquiry made to the redundancy software 64, the user starts the registration process for the management table included in the management program 56, and instructs the registration, modification, or removal of each of the items in the management table 78.

FIG. 11 illustrates an example of a flow of a registration process for registration in the management table 78. During operation of the computer 32, the processing routine illustrated in FIG. 11 is started by the user operating the input device 47, and, for example, instructing execution of a registration process. First, by operating the input device 47, the user inputs the command name of the order representing an enquiry to the redundancy software 64, and the title of the redundant device. The values input by the user are acquired by the CPU 42 of the computer 32 at step 160. Next, when, for example, there has not been a key-press instruction via a predetermined an END key during the operation of the input device 47 by the user (when negative determination is made at step 162), the CPU 42 repeats acquisition of information input values related to a redundancy command until key-press instruction. When affirmative determination is made at step 162, at step 164 the CPU 42 registers the input values acquired at step 160 in the management table 78, and ends the present processing routine.

As illustrated in FIG. 2, computers 32, 34 are connected to the network 36 of the computer system 30. Since the computers 32, 34 are configured similarly to each other, components of the computer 34 similar to those of the computer 32 are appended with the same reference numerals, and detailed explanation thereof is omitted.

Explanation next follows regarding operation of the first exemplary embodiment. In the first exemplary embodiment, processing for making I/O requests to the computer 32 is explained as an example of suppressing response delay of a redundant storage device.

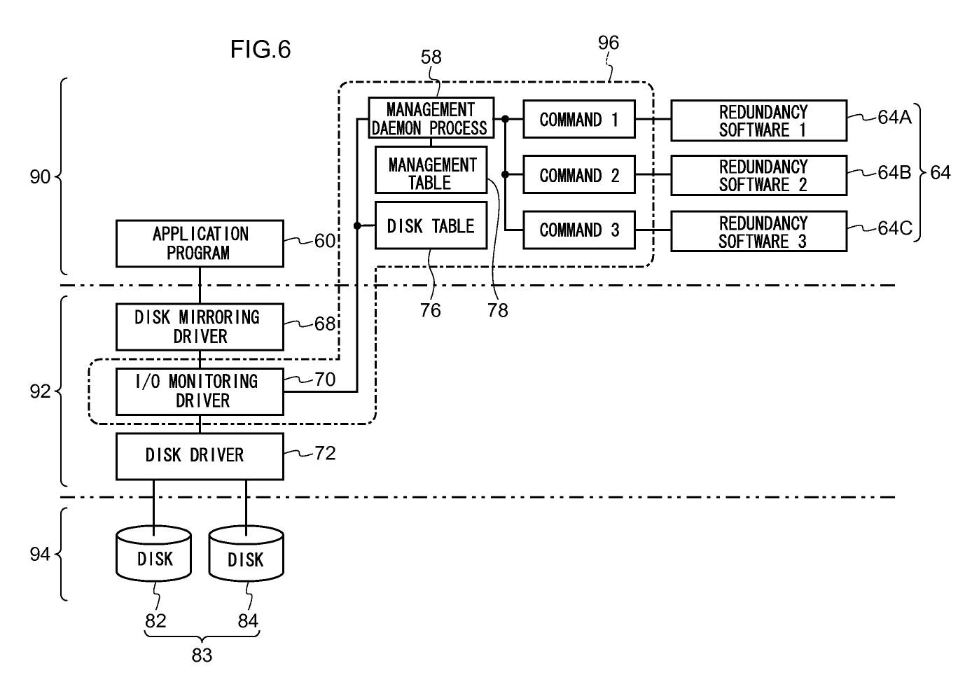

FIG. 5 illustrates an example of primary functional blocks that handle functions related to operation of the computer 32 in the computer system 30. FIG. 6 illustrates an example of a hierarchical structure for software functions during operation in the computer 32. FIG. 6 illustrates an example classified into a user layer 90, a kernel layer 92, and a hardware layer 94, as an example of a layer structure related to operation of the computer 32 according to the first exemplary embodiment.

The disks 82, 84 are subject to redundant in the first exemplary embodiment. For example, the same data is recorded on both the redundant disks 82, 84 when data is recorded. Moreover, when data is read, this is performed by the redundancy software using a predetermined disk of the disk 82 or the disk 84. Rather than being individually identified, the redundant disks 82, 84 are identified as a single virtual disk. In order to simplify explanation below, explanation is given of a case in which the disks 82, 84 are handled as a single virtual disk, disk 83. Explanation is given in which the disk 82 out of the redundant disks 82, 84 is the master disk.

The disks 82, 84 are subjected to redundancy by the redundancy software 64 in the computer 32, and the application program 60 at the user layer 90 requests reading/writing of data from/to the redundant disk 83 at the redundant hardware layer 94. When the application program 60 requests reading/writing of data, the disk mirroring driver 68 at the kernel layer 92 makes an I/O request to the target disk 83 via the disk driver 72. Namely, the disk mirroring driver 68 makes an I/O request to the master disk 82 that is the target, via the disk driver 72. When the disk driver 72 receives an I/O request, the disk driver 72 returns the state of the disk 82 as a response to the disk mirroring driver 68.

The I/O request made by the disk mirroring driver 68, and the response from the disk driver 72, are monitored by the I/O monitoring driver 70 at the kernel layer 92. The I/O monitoring driver 70 checks the disk table 76 (FIG. 3), and determines whether or not the target disk is subject to redundancy. When the target disk is subject to redundancy, the I/O monitoring driver 70 starts I/O monitoring of the target disk 83. Namely, when there is no response from the disk driver 72 within the predetermined timeout time, the I/O monitoring driver 70 takes this as indicating that a response delay has occurred, and makes an enquiry to the management daemon process 58 at the user layer 90 as to whether or not timeout functionality is implementable. The management daemon process 58 checks the management table 78 (FIG. 4) of the redundancy software, acquires the command that checks the redundancy state, and issues the acquired command to the target redundancy software 64 at the user layer 90.

FIG. 6 illustrates an example in which the redundancy software 64 includes three redundancy softwares 64A, 64B, 64C. The redundancy software 64A, 64B, 64C in FIG. 6 are denoted as redundancy software 1, redundancy software 2, and redundancy software 3, respectively. The corresponding enquiry commands for each of the redundancy software 64A, 64B, 64C in FIG. 6 are denoted as a command 1, a command 2, and a command 3, respectively. Although an example is given in FIG. 6 in which three redundancy softwares 64A, 64B, 64C are included as the redundancy software 64, it is sufficient that one or more is included in the redundancy software 64.

The redundancy software 64 returns the redundancy state to the management daemon process 58, according to the received command. The management daemon process 58 determines whether or not timeout functionality is implementable based on the reply from the redundancy software 64, and responds to the I/O monitoring driver 70. When information indicating that timeout functionality is implementable is received from the management daemon process 58, the I/O monitoring driver 70 implements timeout functionality that returns that a timeout has occurred to the disk mirroring driver 68 without waiting for a response from the disk driver 72. The I/O monitoring driver 70 that processes using the disk table 76, and the management daemon process 58 that processes using the management table 78, thereby function as a timeout discrimination section 96 for implementing timeout functionality.

Next, further explanation follows regarding operation of the computer 32.

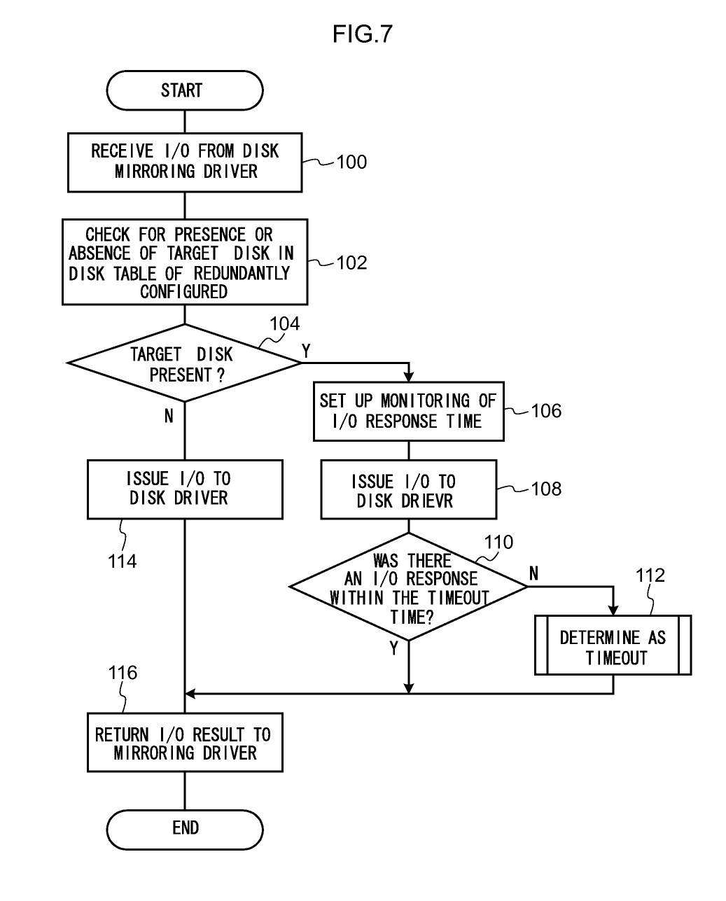

FIG. 7 illustrates a flow of processing of the I/O monitoring driver 70 executed by the computer 32 at the kernel layer 92. During operation of the computer 32, the processing routine illustrated in FIG. 7 is executed when an I/O request is issued by the disk mirroring driver 68. Namely, the CPU 42 of the computer 32 executes the processing routine illustrated in FIG. 7 for each I/O request made by the disk mirroring driver 68.

The CPU 42 of the computer 32 receives the I/O request from the disk mirroring driver 68 at step 100. Next, at step 102 the CPU 42 references the disk table 76 to check whether or not the target disk is registered in the disk table 76. When the target disk is registered in the disk table 76, the CPU 42 makes affirmative determination at step 104, and processing transitions to step 106. However, the I/O request is for a non-redundant disk when the target disk is not registered in the disk table 76. An I/O request for a non-redundant disk is performed accordingly. Namely, when the target disk is not registered in the disk table 76 (when negative determination is made at step 104), the CPU 42 issues an I/O request to the disk driver 72 at step 114, and awaits a response from the disk driver 72. When there is a response from the disk driver 72, at step 116 the CPU 42 returns, to the disk mirroring driver 68, the result of the I/O request, this being the response from the disk driver 72, and ends the present processing routine.

When the target disk is registered in the disk table 76, I/O monitoring of the target disk 83 is started since the I/O request is for a redundant disk. Namely, at step 106 the CPU 42 sets up monitoring of the I/O response time by setting a predetermined timeout time for I/O monitoring as a monitoring time. Next, at step 108 the CPU 42 issues the I/O request to the disk driver 72. Next, at step 110, the CPU 42 awaits a response from the disk driver 72 during the set timeout time. When there is a response from the disk driver 72 within the timeout time, this indicates that the redundant disk 83 is operating normally. Accordingly, when there is a response from the disk driver 72 within the timeout time (when affirmative determination is made at step 110), at step 116, the CPU 42 returns, to the disk mirroring driver 68, an I/O request result that there is a response from the disk driver 72.

When there is no response from the disk driver 72 within the timeout time, this indicates the possibility that some sort of failure has arisen in the disk 82 that is the master for the redundant disk 83, leading to response delays. Cases in which some sort of failure arises in the master disk 82 include cases in which there is the possibility to circumvent response delays. When there is no response from the disk driver 72 within the timeout time (when negative determination is made at step 110), at step 112, the CPU 42 performs timeout determination processing, after which processing transitions to step 116.

Next, further explanation follows regarding the timeout determination processing of step 112 illustrated in FIG. 7.

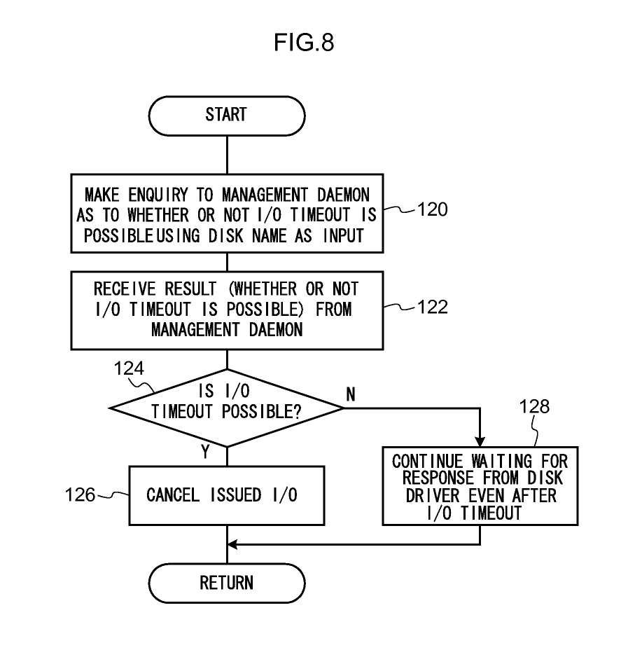

FIG. 8 illustrates an example of a flow of timeout determination processing. Firstly in the timeout determination processing, at step 120 the CPU 42 of the computer 32 executes processing to make an enquiry to the management daemon process 58 of the management program 56. Processing to make an enquiry to the management daemon process 58 is processing that enquires as to whether there is a timeout possibility indicating whether or not there is a redundancy state in which timing out is possible for I/O requests made to the target disk. Specifically, the CPU 42 sends to the management daemon process 58 an enquiry that inputs the title (disk name) of the target disk checked at step 102, and awaits a reply from the management daemon process 58. As described below, the management daemon process 58 replies with information indicating whether there is a timeout possibility.

Next, at step 112 the CPU 42 receives information indicating whether there is a timeout possibility as a reply from the management daemon process 58. When the redundancy state is that the target disk (82) is subject to redundancy and operating normally, switching from operation by the target disk (82) to operating by another redundant disk (84) is possible. Namely, there is the possibility of timeouts to I/O requests by the target disk (82) in order to switch to operation of the other redundant disk (84). When information indicating a redundancy state with switchable operation is received as information indicating that timeout is possible (when affirmative determination is made at step 124), at step 126 the CPU 42 cancels the I/O request issued to the disk driver 72, and ends the present processing routine.

At step 116 of FIG. 7, without waiting for a response from the disk driver 72, the result of I/O request, namely information indicating that there is no response from the target disk 82, can accordingly be returned to the disk mirroring driver 68. When the disk mirroring driver 68 receives information indicating that there was no response from the target disk 82, the redundancy software 64 is able to switch from operation by the target disk 82, to operation by the other redundant disk 84.

When the redundancy state is such that operation is not switchable from the target disk (82), operation by the target disk (82) is required. When information indicating a state in which switching operation is problematic is received by the CPU 42 as information indicating that timing out is problematic (when negative determination is made at step 124), processing transitions to step 128. At step 128, a response from the disk driver 72 is awaited even after the timeout time set at step 106 (FIG. 7) has elapsed, and the present processing routine is ended when a response arrives from the disk driver 72.

Next, explanation follows regarding processing of the management daemon process 58.

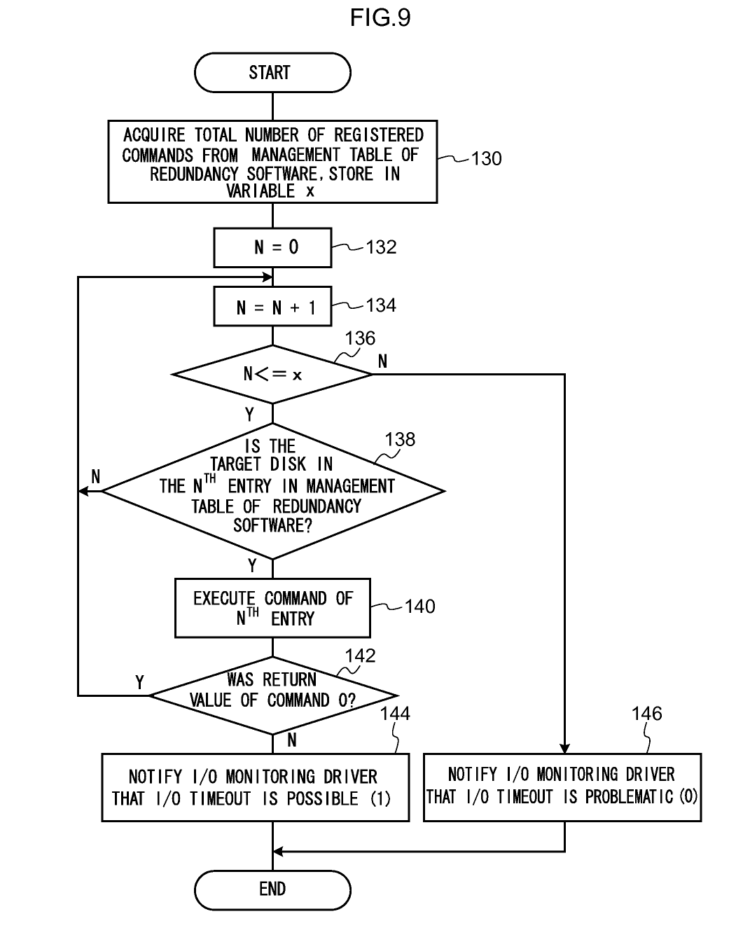

FIG. 9 illustrates an example of a flow of processing of the management daemon process 58 executed at the user layer 90 by the computer 32. The processing routine illustrated in FIG. 9 is executed when an enquiry is output from the I/O monitoring driver 70 during operation of the computer 32. Namely, the CPU 42 of the computer 32 executes the processing routine illustrated in FIG. 9 for each enquiry made by the I/O monitoring driver 70.

At step 130, the CPU 42 of the computer 32 checks the management table 78, acquires the total number of commands that have been registered in the management table 78, and stores the acquired number in a variable x. In the example of the management table 78 illustrated in FIG. 4, since four corresponding command name and disk pairs have been registered, the value “4” is stored in the variable x. The total number of commands acquired at step 130 is the number of registrations in the management table 78, and even if plural commands with the same command name are registered, they are counted plural times.

Next, at step 132 the CPU 42 resets a counter variable N (N=0), and at the next step 134, the counter variable N is incremented by 1 (N=N+1). Next, at step 136 the CPU 42 determines whether or not the value of the counter variable N is less than or equal to the value of the variable x (N≦x). When the value of the counter variable N exceeds the value of the variable x, the enquiry result for the redundancy state of the redundancy software 64 that subjects the target disk to redundancy indicates that the redundancy state of the target disk is not switchable, and that timing out is problematic. When N>x (when negative determination is made at step 136), at step 146 the CPU 42 accordingly returns (notifies), to the I/O monitoring driver 70, information indicating a redundancy state in which switching of operation is problematic, namely, information indicating that timing out is problematic, and ends the present processing routine.

When the value of the counter variable N is less than or equal to the value of the variable x, this means that there is remaining information in the management table 78 related to enquiry commands of redundancy states. Thus when the value of the counter variable N is a value less than or equal to the variable x (when affirmative determination is made at step 136), at step 138 the CPU 42 determines whether or not the target disk is included in the N^{th} information entry of the management table 78. Namely, determination is made as to whether or not the N^{th} information entry for the DISK item of the management table 78 includes the disk name of the target disk. When the information of the DISK item does not include the disk name of the target disk (when negative determination is made at step 138), the N^{th} information entry of the management table 78 is unrelated to the target disk. When negative determination is made at step 138, the CPU 42 returns processing to step 134, and processing transitions to the next information entry in the management table 78.

When the disk name of the target disk is included in the information of the DISK item (when affirmative determination is made at step 138), at step 140 the CPU 42 executes the command in the N^{th} information entry of the management table 78. Namely, a command is executed according to the information of the COMMAND NAME item of the N^{th} information entry in the management table 78. When the redundancy software 64 executes the command, the redundancy state of the redundant disk managed by that redundancy software 64 is checked, and information indicating the check result is returned to the management daemon process 58. An example of the information indicating the check result according to the redundancy software 64, is information indicating a redundancy state with switchable operation, or information indicating a state in which switching of operation is problematic. For the information indicating the check result according to the redundancy software 64, “1” may be returned as a value indicating a redundancy state with switchable operation. Moreover, “0” may be returned as a value indicating a state in which switching of operation is problematic.

When the value indicating the check result returned from the redundancy software 64 is “0” (when affirmative determination is made at step 142), the N^{th} information entry of the management table 78 indicates that switching of operation is problematic. The CPU 42 returns processing to step 134, and processing transitions to the next information entry in the management table 78.

When the value indicating the check result returned from the redundancy software 64 is “1” (when negative determination is made at step 142), the N^{th} information entry in the management table 78 indicates that operation is switchable. Thus, at step 144 the CPU 42 returns (notifies), to the I/O monitoring driver 70, information indicating a redundancy state in which switching operation is possible, namely, information indicating that timing out is possible, and ends the present processing routine.

As explained above, in the first exemplary embodiment, if the target disk 83 is subjected to redundancy by the redundancy software 64, timeout functionality that informs of timeouts without awaiting a response from the disk driver 72 can be implemented. Namely, timeout functionality does not need to be included in the disk mirroring driver 68 itself. When the target disk 83 is subjected to redundancy by the redundancy software 64, timeout functionality can be implemented by the I/O monitoring driver 70. Accordingly, response times for I/O can be shorted when I/O response delays occur in the computer 32, and the availability of the computer 32 and, therefore, of the entire computer system 30, can be increased.

### Second Exemplary Embodiment

Next, explanation follows regarding the second exemplary embodiment. The second exemplary embodiment applies technology disclosed herein when a computer, such as a server, is subject to redundancy by processing such as that of clustering software. Namely, in the second exemplary embodiment, response delays are suppressed during operation of a computer, and a switch is made to a redundant standby computer. In the second exemplary embodiment, since configuration is substantially similar to that of the first exemplary embodiment, matching reference numerals are assigned to matching portions, and detailed explanation thereof is omitted.

In the second exemplary embodiment, explanation is given regarding an example of subjecting a computer to redundancy using clustering software. Note that explanation is given of a case in which a computer 32 operates as an operating-type server, and a computer 34 operates as a standby-type server.

In the following explanation, the operating-type computer 32 uses the same reference numbers as in the first exemplary embodiment, and detailed explanation thereof is omitted. Moreover, explanation is given of an example in which the standby-type computer 34 is configured substantially similarly to the operating-type computer 32, and uses the reference numerals of the computer 32 suffixed with “S” to distinguish between the computers 32, 34.

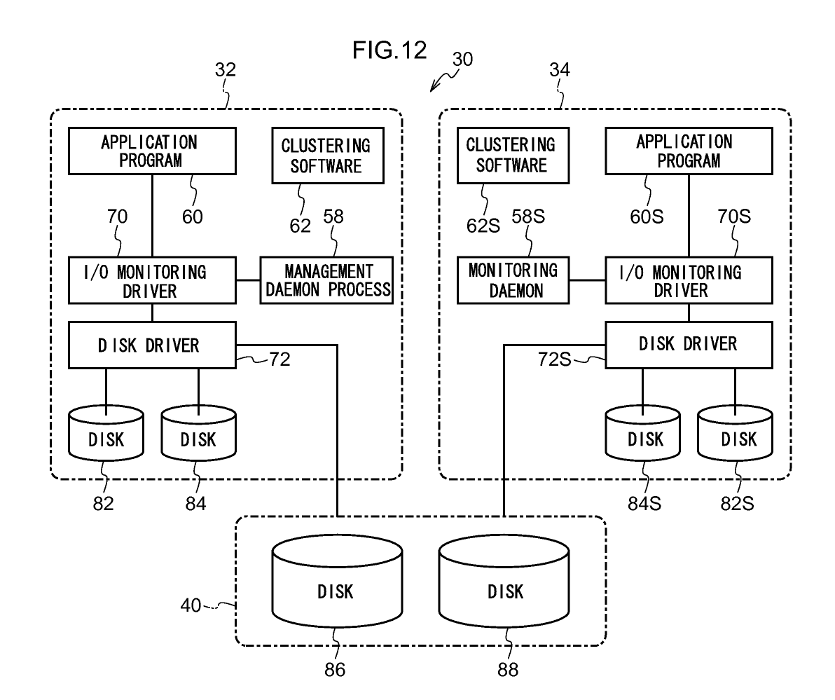

FIG. 12 illustrates an example of primary functional blocks that carry out functions related to operation of the computer 32 in a computer system 30 according to the second exemplary embodiment.

In the computer system 30, the computer 32 includes clustering software 62, and the computer 34 includes clustering software 62S. The computer 32 is made redundant together with the computer 34. Namely, the computer 32 and the computer 34 are always maintained in the same states as each other, such that the computer 34 can be switched to operating-type if an operating fault arises in the computer 32.

In the computer 32, the application program 60 at the user layer 90 requests reading/writing of data from/to the disk 82 or the disk 84. When the application program 60 requests reading/writing of data, an I/O request is made to the target disks 82, 84 via the disk driver 72 at the kernel layer 92. The disk driver 72 receives an I/O request, and returns, for example, the state of the disk 82 to the application program 60. For simplicity of explanation, in the computer 32, the application program 60 requests reading/writing of data from/to the disk 82.

The I/O monitoring driver 70 monitors I/O requests and responses from the disk driver 72. The I/O monitoring driver 70 checks the disk table 76, and determines whether or not the target disk is subject to redundancy. In the second exemplary embodiment, since the computer is subject to redundancy, all of the disks in the computer 32 are subject to redundancy and registered in the disk table 76.

The disk table 76 according to the second exemplary embodiment is used to discriminate redundant disks in the I/O monitoring driver 70, and information for managing the redundant disks is stored as a table in the database 74. An example of the information for managing the redundant disks is titles (disk names) of disks that identify the redundancy target disks included in the redundant computer.

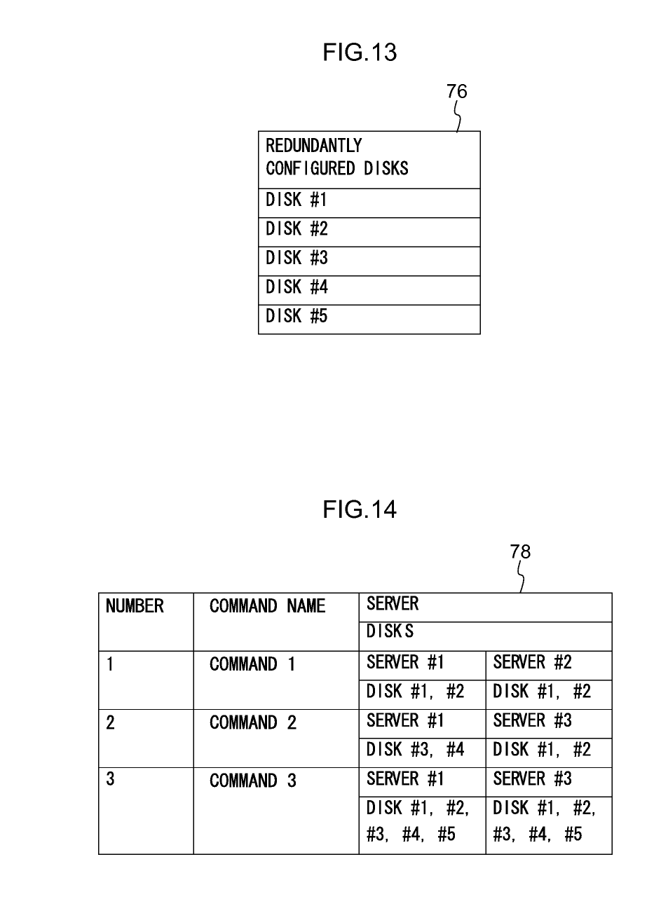

FIG. 13 illustrates an example of the disk table 76 according to the second exemplary embodiment. In example of the disk table 76 illustrated in FIG. 13, DISK #1, DISK #2, DISK #3, DISK #4, and DISK #5 are stored to indicate the titles of redundant disks.

The disk table 76 is pre-registered by a user. For example, when registration, modification, or removal of a disk subjected to redundancy by the clustering software 62 occurs, the user starts up a disk table registration process included in the management program 56, and instructs the registration, modification, or removal in the disk table 76.

Since the computer 32 is subjected to redundancy by the clustering software 62, the I/O monitoring driver 70 starts I/O monitoring the disks 82. Namely, when there is no response from the disk driver 72 within a predetermined timeout time, the I/O monitoring driver 70 takes this as indicating that a response delay has occurred, and makes an enquiry to the management daemon process 58 at the user layer 90 as to whether or not timeout functionality is implementable. The management daemon process 58 checks the management table 78 of the redundancy software, acquires a command for checking the redundancy state, and issues the acquired command to the target clustering software 62 at the user layer 90.

The management table 78 according to the second exemplary embodiment is employed when the management daemon process 58 makes an enquiry to the clustering software 62, and information related to the enquiry to the clustering software 62 is stored as a table in the database 74. Examples of the information related to the enquiry to the clustering software 62 include, a check command name for the redundancy state corresponding to the clustering software 62, a computer title, and a title of a disk included in the computer.

FIG. 14 illustrates an example of a management table 78 according to the second exemplary embodiment. Respective information representing a NUMBER, a COMMAND NAME and clustering are each registered associated with one another in the management table 78. The information representing clustering is information indicating relationships between computers clustered by the clustering software 62. FIG. 14 illustrates an example in which respective information representing SERVER and DISKS are registered associated with each other.

The information representing the SERVER item is information indicating computers clustered by the clustering software 62. The information representing the DISKS item is information indicating disks that are clustering targets in the computers subjected to redundancy by the target clustering software 62. In the example of number 1 illustrated in FIG. 14, information of SERVER #1 is registered in the SERVER item for the operating-type computer 32, and information of DISK #1, DISK #2 is registered in association therewith in the DISKS item for disk 82, disk 84. Information of SERVER #2 is registered in the SERVER item for the standby-type computer 34, and information of DISK #1, DISK #2 is registered in association therewith in the DISKS item for disk 82S, disk 84S.

The management table 78 is preregistered by the user. For example, when registration, modification, or removal has appeared in the information related to the enquiry made to the clustering software 62, the user starts the registration process for the management table included in the management program 56, and instructs the registration, modification, and removal of items in the management table 78.

According to the received command, the clustering software 62 returns the redundancy state to the management daemon process 58. The management daemon process 58 determines whether or not timeout functionality is implementable based on the reply from the clustering software 62, and responds to the I/O monitoring driver 70. When information indicating that timeout functionality is implementable is received from the management daemon process 58, the I/O monitoring driver 70 executes timeout functionality returning that there was a timeout to the application program 60 without waiting for a response from the disk driver 72. The I/O monitoring driver 70 that processes using the disk table 76, and the management daemon process 58 that processes using the management table 78, thereby function as a timeout discrimination section 96 (FIG. 6) for implementing timeout functionality.

When information indicating that the I/O request has timed out is received, the application program 60 can notify the clustering software 62. When information is received indicating that an I/O request by the application program 60 has timed out, the clustering software 62 can switch the standby-type computer 34 to being the computer in operation. Information indicating that there was a time out may be directly received by the clustering software 62. The clustering software 62 can accordingly switch between computers before response delays arise in the operating-type computer 32 and lead to impediments to operation of the computer 32.

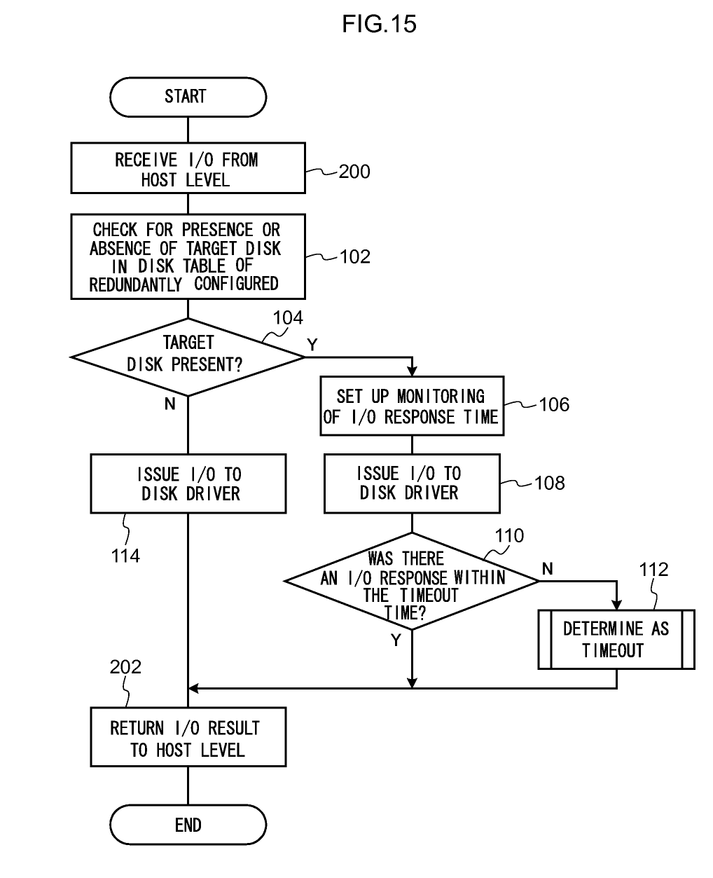

FIG. 15 illustrates a flow of processing of the I/O monitoring driver 70 executed by the computer 32 at the kernel layer 92 according to the second exemplary embodiment. The processing routine illustrated in FIG. 15 is executed when an I/O request is issued to the disks during operation of the computer 32. Namely, the CPU 42 of the computer 32 executes the processing routine illustrated in FIG. 15 for each I/O request made to the disks 82, 84.

At step 200, the CPU 42 of the computer 32 receives an I/O request made to the disks. For example, the CPU 42 receives an I/O request made to the requested disk 82 from the application program 60. The CPU 42 then checks the registration of the target disk in the disk table 76 (step 102), and when the target disk is registered (when affirmative determination is made at step 104), processing transitions to processing similar to step 106 to step 112 of the first exemplary embodiment. However, when the target disk is not registered in the disk table 76 (when negative determination is made at step 104), an I/O request is made to the non-redundant disk. Thus, when an I/O request is made to the disk driver 72 (step 114), a response from the disk driver 72 is awaited. When there is a response from the disk driver 72, at step 202 the CPU 42 returns the result of the I/O request that is the response from the disk driver 72 to the host software (in this example, the application program 60), and ends the present processing routine.

When I/O monitoring is started on the disk 82 and there is no response from the disk driver 72 within the timeout time (when affirmative determination is made at step 104, followed by negative determination at step 110), timeout determination processing is performed (step 112).

In the timeout determination processing, the CPU 42 executes processing to make an enquiry to the management daemon process 58 (see also, FIG. 8). The CPU 42 sends an enquiry to the management daemon process 58, and executes processing on the target disk 82 according to the reply information indicating whether or not timing out is possible. Namely, switching of operation to the disk 82S included in the redundant standby-type computer 34 is possible when timeouts are possible. When information is received indicating that timeouts are possible, the CPU 42 accordingly cancels the I/O request issued to the disk driver 72, and ends the present processing routine. The result of the I/O request can accordingly be returned to the application program 60 without awaiting a response from the disk driver 72.

Similarly to the first exemplary embodiment, the management daemon process 58 executes when an enquiry is output from the I/O monitoring driver 70 (see also, FIG. 9).

In the management daemon process 58, the management table 78 is checked regarding the redundant computers, and a redundancy state enquiry is performed on the clustering software 62 by executing the command. According to the value of the information indicating the redundancy state indicated in the reply from the clustering software 62, the management daemon process 58 notifies the I/O monitoring driver 70 with information indicating whether or not timing out is possible.

As explained above, in the second exemplary embodiment, if a disk of a computer is subjected to redundancy by the clustering software 62, timeout functionality can be implemented that informs of timeouts without awaiting a response from the disk driver 72. Namely, it is not necessary to include a timeout functionality in the kernel layer driver, related to the clustering software 62, itself. Timeout functionality can also be implemented by the I/O monitoring driver 70 when a disk of a computer is subjected to redundancy by the clustering software 62. Implementing the timeout functionality using the I/O monitoring driver 70 enables swift switching to the computer 34 before I/O response delays occur in the computer 32. Accordingly, the I/O response time for a disk of a computer subjected to redundancy by clustering can be shortened, and the availability of the entire computer system 30 can be increased.

Explanation has been given of an example in which the data processing device 10 is implemented by the computer system 30. However, there is no limitation to this configuration, and obviously, various improvements and modifications may be implemented within a scope not exceeding the spirit of the invention.

Although explanation has been given of a mode in which programs are prerecorded (installed) in a storage section, there is no limitation thereof. For example, the data processing program of technology disclosed herein may be provided in a mode recorded on a recording medium such as a CD-ROM or DVD-ROM.

An aspect of technology disclosed herein is applicable to redundancy technology during operation and enables continuation of business processing without delays, and enables availability with respect to business processing to be increased.

All publications, patent applications, and technical standards mentioned in the present specification are incorporated by reference in the present specification to the same extent as if the individual publication, patent application, or technical standard was specifically and individually indicated to be incorporated by reference.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A data processing device, comprising:
a processor configured to execute a process, the process comprising:
outputting, toward a specific storage device among a plurality of storage devices including switchable storage devices that are subjected to redundancy by a redundancy section so as to store the same data as another storage device, request information that requests data input/output processing, and instructing input/output of the data;
performing input/output of data for each of the plurality of storage devices, and performing a response after the request information has been received; and
pre-storing redundancy information related to the redundant switchable storage devices, and based on the redundancy information, monitoring responses to the request information aimed at the redundant switchable recording devices.

2. The data processing device of claim 1, wherein:
during monitoring for a response to the request information, when the specific storage device is subject to redundancy together with another storage device, responses to the request information aimed at the specific storage device are monitored for a specific time, and when there is no response to the request information aimed at the specific storage device within the specific time, before any response to the request information, information is output indicating that there has been no response to the request information aimed at the specific storage device.

3. The data processing device of claim 1, wherein:
the redundancy information includes disk information indicating a relationship between another redundant storage device and the specific storage device; and
during monitoring for a response to the request information, determination is made as to whether or not the specific storage device is subject to redundancy together with another storage device based on the disk information.

4. The data processing device of claim 1, wherein:
the redundancy information includes management information indicating a redundancy state in which the specific storage device and another storage device operate subject to redundancy with each other; and
during monitoring for a response to the request information, responses to the request information corresponding to the redundancy state between the specific storage device and another storage device are monitored based on the management information.

5. The data processing device of claim 4, wherein:
during monitoring for a response to the request information, the request information is erased and information indicating that there has been no response to the request information aimed at the specific storage device is dispatched in a case of a state in which the specific storage device and the other storage device operate subject to redundancy with each other; and
the request information is preserved and information indicating any response to the request information is dispatched in a case of a state in which the specific storage device and another storage device do not operate subject to redundancy with each other.

6. The data processing device of claim 4, wherein:
the redundancy information includes a command representing an order that causes output of management information indicating that the specific storage device and another storage device are operating subject to redundancy with each other; and
during the monitoring for a response to the request information, the command is output to the redundancy section, and responses to the request information are monitored based on management information given in response to this output.

7. The data processing device of claim 1, wherein the redundancy section executes disk mirroring processing that effects redundancy such that a plurality of storage devices store the same data.

8. The data processing device of claim 1, wherein the redundancy section executes clustering processing that effects redundancy such that a plurality of computers including a storage device store the same data.

9. A data processing method, comprising:
outputting, toward a specific storage device among a plurality of storage devices including switchable storage devices that are subjected to redundancy by a redundancy section so as to store the same data as another storage device, request information that requests data input/output processing, and instructing input/output of the data;
performing input/output of data for each of the plurality of storage devices, and performing a response after the request information has been received; and
by a processor, pre-storing redundancy information related to the redundant switchable storage devices, and based on the redundancy information, monitoring responses to the request information aimed at the redundant switchable recording devices.

10. The data processing method of claim 9, wherein:
during monitoring for a response to the request information, when the specific storage device is subject to redundancy together with another storage device, responses to the request information aimed at the specific storage device are monitored for a specific time, and when there is no response to the request information aimed at the specific storage device within the specific time, before any response to the request information, information is output indicating that there has been no response to the request information aimed at the specific storage device.

11. The data processing method of claim 9, wherein:
the redundancy information includes disk information indicating a relationship between another redundant storage device and the specific storage device; and
during monitoring for a response to the request information, determination is made as to whether or not the specific storage device is subject to redundancy together with another storage device based on the disk information.

12. The data processing method of claim 9, wherein:
the redundancy information includes management information indicating a redundancy state in which the specific storage device and another storage device operate subject to redundancy with each other; and
during monitoring for a response to the request information, responses to the request information corresponding to the redundancy state between the specific storage device and another storage device are monitored based on the management information.

13. The data processing method of claim 12, wherein:
during monitoring for a response to the request information, the request information is erased and information indicating that there has been no response to the request information aimed at the specific storage device is dispatched in a case of a state in which the specific storage device and the other storage device operate subject to redundancy with each other; and
the request information is preserved and information indicating any response to the request information is dispatched in a case of a state in which the specific storage device and another storage device do not operate subject to redundancy with each other.

14. The data processing method of claim 12, wherein:
the redundancy information includes a command representing an order that causes output of management information indicating that the specific storage device and another storage device are operating subject to redundancy with each other; and
during the monitoring for a response to the request information, the command is output to the redundancy section, and responses to the request information are monitored based on management information given in response to this output.

15. The data processing method of claim 9, wherein the redundancy section executes disk mirroring processing that effects redundancy such that a plurality of storage devices store the same data.

16. The data processing method of claim 9, wherein the redundancy section executes clustering processing that effects redundancy such that a plurality of computers including a storage device store the same data.

17. A non-transitory recording medium storing a data processing program that causes a computer to execute a process, the process comprising:
outputting, toward a specific storage device among a plurality of storage devices including switchable storage devices that are subjected to redundancy by a redundancy section so as to store the same data as another storage device, request information that requests data input/output processing, and instructing input/output of the data;
performing input/output of data for each of the plurality of storage devices, and performing a response after the request information has been received; and
pre-storing redundancy information related to the redundant switchable storage devices, and based on the redundancy information, monitoring responses to the request information aimed at the redundant switchable recording devices.
